(19) United States
(12) Patent Application Publication
(10) Pub. No.: US 2025/0292414 A1
(43) Pub. Date: Sep. 18, 2025

(54) MULTI-SENSOR SUBJECT TRACKING FOR MONITORED ENVIRONMENTS FOR REAL-TIME AND NEAR-REAL-TIME SYSTEMS AND APPLICATIONS

(71) Applicant: NVIDIA Corporation, Santa Clara, CA (US)

(72) Inventors: Zheng TANG, Bothell, WA (US); Sujit BISWAS, Newark, CA (US); Ganapathy Seshadri Cadungude AIYER, San Jose, CA (US); Shuo WANG, San Jose, CA (US); Akshay AGRAWAL, Santa Clara, CA (US); Sameer Satish PUSEGAONKAR, San Francisco, CA (US)

(21) Appl. No.: 18/605,121

(22) Filed: Mar. 14, 2024

(51) Int. Cl. G06T 7/20; G06V 10/762; G06V 40/20

(52) U.S. Cl. CPC G06T 7/20; G06V 10/762; G06V 40/20; G06V 2201/07

(57) ABSTRACT

In various examples, multi-sensor subject tracking for monitored environments for real-time and near-real-time systems and applications are provided. A location system performs multi-subject tracking using streaming data from multiple sensors. Subject tracking may be based on individual anchors and behavior states that are initialized for individual subjects using representations (e.g., behavior embeddings) derived from the streaming data. Clustering may be used to generate behavior clusters that individually represents a trackable subject. Behavior states for live anchors may identified based on continuity of trajectory and tracked by iteratively propagating their behavior states forward over time. Clusters lacking continuity of trajectory may be used to initialize new anchors, or matched to dormant anchors that may be reclassified as live anchors and propagated. Propagated behavior states may be updated using behavior data represented by the behavior embeddings.

### BACKGROUND

Multi-subject multi-camera (MTMC) tracking is a computer vision-based technology that simultaneously monitors and tracks the movements of numerous objects (subjects) across multiple camera views—taking input from video feeds captured by multiple (potentially non-overlapping) cameras, and applying algorithms and/or machine learning techniques to analyze video streams to track and identify subjects of interest. MTMC tracking may be used in applications such as security and surveillance, vehicle traffic monitoring, monitor activities in transit, factories and warehouses, in retail analytics to monitor customer behaviors in a retail store, and/or crowd management/public safety at events, gatherings, or public spaces.

### SUMMARY

Embodiments of the present disclosure relate to multi-sensor subject tracking for monitored environments for real-time and near-real-time systems and applications. Systems and methods disclosed herein may be used to track multiple subjects within a monitored area, across the views of a plurality of image sensors, to produce tracking solutions for a plurality of subjects within one second of capturing image data.

In contrast to existing MTMC tracking technologies, the systems and method described herein provide for a real-time location system (RTLS) that may perform multi-subject tracking using real-time (e.g., live), or near-real time, streaming data from multiple sensors viewing a monitored area. A monitored area may comprise any area within which subjects of interest may be traveling such as, but not limited to, warehouses, factories, retail establishments, office buildings, secured facilities, arenas, public transportation stations, parks, public spaces, and the like.

RTLS subject tracking may be based on defining a set of initialized anchors, wherein individual anchors are initialized for each individual subject recognized from the live streaming data. The live streaming data may be processed in micro-batches (e.g., a set of synchronized streaming data from the multiple sensors spanning a sub-second duration of time) so that rendered subject tracking data is fresh (e.g., current to within one second) with respect to the actual position of tracked subjects. The RTLS may receive a set of synchronized optical image streaming data that comprises, for example, video image feeds from a plurality of optical images sensors. The video image feeds may be synchronized such that the streaming data comprises individual image feeds from different optical images sensors that capture image data at the same time. The video image feeds may include timestamps that can be used to align contemporaneously captured image data from the multiple feeds.

In some embodiments, an anchor and an associated behavior state may be initialized to represent a subject that is detectable from the streaming data. Each initialized anchor may be maintained in an RTLS state. An anchor for a tracked subject may be used to track or determine behavior data for the tracked subject across the fields of view of the multiple optical image sensors. In steady-state operation, anchors may be tracked based on a continuity of trajectory analysis that associates prior behavior states from the prior micro-batch of live streaming data with representations (e.g., behavior embeddings) derived from the current micro-batch of live streaming data, to identify live anchors that may be propagated forward (e.g., carried over) from the prior micro-batch of live streaming data. Remaining representations that cannot be tracked based on a continuity of trajectory analysis may represent subjects that are not represented in the most recent prior micro-batch of live streaming data. In some cases, one or more of those representations may be associated with a dormant anchor, for example, a previously initialized anchor for a subject that has not appeared in the most recent micro-batche(s) of live streaming data. To identify when remaining representations are associated with a dormant anchor, the RTLS may perform a hierarchical clustering process to group the remaining behaviors into a set of one or more clusters based on a similarity of representations.

Once clustering is performed, the RTLS may execute a matching algorithm to determine if one or more of the remaining representations associated with a cluster match (e.g., are similar to) representations associated with a dormant anchor. If a cluster is determined to match with a dormant anchor, then the RTLS may perform behavior state management that re-classifies that dormant anchor as a live anchor, and the behavior state of the anchor may be updated based on the current representations forming the cluster. If a cluster of remaining representations is determined to not match with a dormant anchor, then that cluster may represent behaviors associated with a subject not previously observed by the RTLS, or that may have been previously associated with a dormant anchor that has expired (e.g., that was deleted based on age and/or other data staleness criteria). In that case, the RTLS may initialize a new live anchor associated with that cluster, initialize a new global ID assigned to that new anchor, and initialize a behavior state for the new anchor based on the current representations forming the cluster.

Subject tracking data derived from behavior states of live anchors may be used as input, for example, by one or more subject evaluation systems. For example, subject tracking data may be used by a rendering system to display a comprehensive view of the monitored area and visually render location and trajectory tracking data for each subject in the area and/or other applications.

### BRIEF DESCRIPTION OF THE DRAWINGS

The present systems and methods for multi-sensor subject tracking for monitored environments for real-time and near-real-time systems and applications are described in detail below with reference to the attached drawing figures, wherein:

FIG. 1 is a data flow diagram illustrating a real-time location system, in accordance with some embodiments of the present disclosure;

FIG. 2 is a data flow diagram illustrating a behavior extraction process, in accordance with some embodiments of the present disclosure;

FIG. 3 is a data flow diagram illustrating a real-time location system state management process, in accordance with some embodiments of the present disclosure;

FIGS. 4A and 4B are diagrams that illustrate example user interface displays generated by a real-time location system, in accordance with some embodiments of the present disclosure;

FIG. 5 is a flow chart illustrating a method for a real-time location system, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods disclosed relate to multi-sensor subject tracking for monitored environments for real-time and near-real-time systems and applications.

Historically, camera-based tracking technologies have involved either single object tracking (SOT) or multi-object tracking (MOT) based on image data from a single camera. More recently, multi-camera based tracking has leveraged developments in multi-camera networks to apply techniques for providing comprehensive monitoring of an area from multiple viewpoints. However, multi-camera tracking introduces complexities with respect to tracking subjects across multiple camera views—including performing accurate synchronization and calibration between the cameras, addressing appearance changes in a subjects that may vary with viewpoint, and fusing data from different video streams to distinctly define subjects and associated trajectory tracks.

While object Re-identification (Re-ID) technologies and other advanced matching algorithms have been developed that can take the outputs of object detection algorithms and match them to compute individual trajectories, those techniques face difficulties with respect to scalability and supporting real-time MTMC tracking from live video streams. For example, if a monitored area has five cameras to track ten subjects moving about the area, then potentially up to 50 distinct behavior detections may need to be processed and individually linked to subjects appearing in the video streams, and their respective trajectories tracked over time. If a monitored area has five cameras to track 100 subjects moving about the area, then potentially up to 500 distinct behavior detections may need to be processed and individually linked to subjects appearing in the video streams, and their respective trajectories tracked over time. For a monitored area densely populated with subjects (e.g., such as a grocery store during a peak shopping time), the number of distinct behavior detections that need to be simultaneously processed into distinct subjects (including their respective trajectory data) can quickly overburden the abilities of available compute resources used by the various algorithms to support real-time multi-subject tracking.

In contrast to existing MTMC tracking technologies, the systems and methods described herein provide for a real-time location system (RTLS) that may perform multi-subject tracking using real-time (e.g., live), or near-real time, streaming data from multiple sensors viewing a monitored area. A monitored area may comprise any area within which subjects of interest may be traveling such as, but not limited to, warehouses, factories, retail establishments, office buildings, secured facilities, arenas, public transportation stations, parks, public spaces, and the like.

As discussed herein, RTLS subject tracking may be based on defining a set of initialized anchors, wherein individual anchors are initialized for each individual subject recognized from the live streaming data. The live streaming data may be processed in micro-batches (e.g., a set of synchronized streaming data from the multiple sensors spanning a sub-second duration of time) so that rendered subject tracking data is fresh (e.g., current to within one second) with respect to the actual position of tracked subjects. In some embodiments, distinctive advantages of the RTLS embodiments described herein include, for example and without limitation, capabilities for real-time, or near real-time, processing with sub-second response times, smoother and more continuous ID assignment to tracked subjects as compared to existing MTMC tracking technologies, and/or provide enhanced spatiotemporal scene understanding.

As discussed herein, the RTLS may receive a set of synchronized optical image streaming data that comprises, for example, video image feeds from a plurality of optical images sensors. The video image feeds may be synchronized such that the streaming data comprises individual image feeds from different optical images sensors that capture image data at the same time. In some embodiments, the video image feeds may include timestamps that can be used to align contemporaneously captured image data from the multiple feeds. The RTLS may process the synchronized optical image streaming data as sequential micro-batches (e.g., where each micro-batch defines a distinct sub-second time frame of the synchronized optical image streaming data). In some embodiments, the synchronized optical image streaming data may comprise live-streaming feeds from the plurality of optical image sensors. In some embodiments, the synchronized optical image streaming data may comprise batches of previously recorded live-streaming feeds from the plurality of optical image sensors.

To initialize the RTLS, an initial micro-batch of live streaming data may be processed to generate a set of initialized anchors. Each individual anchor that is initialized by the RTLS represents a subject that is detectable from the live streaming data. In some embodiments, each initialized anchor is maintained in an RTLS state. As described below, the initialization process may comprise processing of the streaming data to compute representations of behavior based on characteristics of detected subjects. In one or more embodiments, the representations of behavior is implemented as behavior embeddings, and the initialization process includes clustering of the behavior embeddings to correlate groupings (e.g., clusters) of the behavior embeddings with the distinct subjects, and assigning an anchor to each cluster. When an anchor is initialized, a behavior state for that anchor is also defined and initialized based on behavior data (e.g., appearance data and spatiotemporal data) for a corresponding distinct subject represented by the behavior embeddings included in its assigned cluster. An anchor for a tracked subject may be used to track or determine behavior data for the tracked subject across the fields of view of the multiple sensors that produce the live streaming data. The term “live anchor” as used herein refers to a previously initialized anchor representing a subject observable from the current micro-batch of live streaming data that has propagated from the most recent prior micro-batch of live streaming data. A “dormant anchor”, in contrast, may refer to a previously initialized anchor associated with a subject that was previously detectable from the live streaming data, but does not appear represented in the last prior micro-batch of live streaming data. In some embodiments, the RTLS state may correlate anchors with their corresponding behavior states, and maintain historical behavior data associated with each initialized anchor. The RTLS state may be updated when new anchors are initialized, and/or when new behavior embeddings are matched successfully with prior behavior states of previously initialized anchors. In some embodiments, historical data from RTLS state may be leveraged to increase the reliability of behavior matching for spans of time beyond the time frame of the current micro-batch.

To generate the set of initialized anchors for initialization of the RTLS, the feeds from the individual cameras may be processed using computer-based perception to perform behavior detection, perform single camera tracking (e.g., subject behavior localization), and generate behavior embeddings (e.g., computing a vector representing a subject) for each detected behavior. A behavior embedding may include encoded behavior data comprising appearance data and/or spatiotemporal data capturing characteristics of a tracked subject. The behavior embeddings may be computed based on behaviors detected, for example, by a machine learning model trained to recognize characteristics of intended subjects (e.g., a model trained to recognized and extract features associated with characteristics of people, vehicles, machines, animals, and/or other subjects of interest). In some embodiments, the RTLS may implement a plurality of parallel live stream data processing paths for processing the feeds from the plurality of cameras to produce behavior embeddings. For example, in some embodiments the RTLS may implement a set of parallel processing paths (e.g., using multiple processing threads and/or multiple core processors) for computing the behavior embedding, where each processing path generates behavior embeddings based on the live stream feed of a respective camera. Behavior embeddings associated with a live anchor may be used to define and/or update a behavior state for that live anchor as discussed below.

Based on a set of behavior embeddings, the RTLS may map the spatiotemporal data from each behavior embedding to a global image coordinate system (e.g., based on extrinsic camera calibration parameters associated with each of the individual cameras) and perform an initial clustering to group behavior embeddings into clusters based on their similarity. For example, a subject (e.g., a person) in a monitored area may be represented in the micro-batch of live streaming data as a detected subject, and represented as a first behavior embedding derived from the feed of a first camera. Similarly, a second behavior embedding may be derived for the detected subject from the feed of a second camera. For each camera, a set of extrinsic calibration parameters (e.g., a rotation-translation transform) may be used to map location information of behaviors extracted from two-dimensional (2D) image data captured by the camera, to a global coordinate system associated with the monitored area. Since the first behavior embedding and the second behavior embedding in this example are both representations of the same subject (person) within the same time frame, the first behavior embedding and the second behavior embedding should share very similar behavior data (e.g., appearance data and spatiotemporal data). Those behavior embeddings therefore would form a cluster that can be uniquely associated with a distinct subject (e.g., the detected person). Moreover, for each additional camera that observes that subject during the time frame, the behavior embedding derived from those camera feeds should also cluster with the behavior embeddings derived from the first and second cameras. Other distinct clusters may form in the same way based on behavior embeddings associated with other subjects represented in the micro-batch of live streaming data. In some embodiments, when the RTLS performs clustering, a hierarchical clustering may be performed to group behavior embeddings into clusters based on their similarity. In some embodiments, the RTLS may apply one or more hierarchical clustering algorithms such as, but not limited to, a balanced iterative reducing and clustering using hierarchies (BIRCH) algorithm, an ordering points to identify the clustering structure (OPTICS) algorithm, a density-based spatial clustering of applications with noise (DBSCAN), a hierarchical DBSCAN (HDBSCAN*), and/or other clustering algorithms.

Each cluster that distinctly represents a subject may be used to initialize a live anchor, and a unique global identifier (global ID) may be assigned to that anchor. Moreover, for each anchor, the RTLS may initialize and maintain a behavior state that may be updated using subsequent micro-batches of live streaming data (e.g., for as long as the anchor continues to be a live anchor). In some embodiments, a global ID may be an anonymized identifier and/or may correlate to a more personal identifier such as a subject's name, employee number, customer number, account number, student number, and/or other identifier associated with a tracked subject.

With the RTLS and the first set of anchors initialized, for subsequent micro-batches of live streaming data (e.g., subsequent time frames), live anchors may be identified based on the streaming data, and their respective corresponding behavior states updated. For example, the feeds from the individual cameras may be processed using computer-based perception to perform behavior detection, single camera tracking, and create behavior embeddings for each detected behavior. The behavior embeddings may be computed by the machine learning model based on the behaviors detected from the live streaming data, and the spatiotemporal data from each behavior embedding mapped to the global image coordinate system. Given the short, sub-second interval of time occurring between each sequential micro-batch of live streaming data, the RTLS may use a continuity of trajectory analysis to associate behavior data from the prior behavior states with behavior embeddings derived from the current micro-batch of live streaming data, to identify live anchors that may be propagated forward (e.g., carried over) from the prior micro-batch of live streaming data. For example, the prior location and trajectory data from the prior behavior state of an anchor may be used to precisely predict an expected current location and trajectory given the elapsed time between iterations. Those behavior embeddings derived from the current micro-batch having spatiotemporal data corresponding to a predicted current location and trajectory (e.g., within a threshold distance) may be used to propagate an anchor and update the behavior state data for that live anchor. In some embodiments, the continuity of trajectory analysis may determine a distance (e.g., a Euclidean distance) between a predicted current location and trajectory, and the location and trajectory represented by one or more behavior embeddings, to associate behavior embeddings with live anchors. A similarity in appearance data from the behavior embeddings may be used to further validate an association between the behavior embeddings and a live anchor.

Advantageously, a live anchor can be propagated forward from the prior micro-batch, without a need to perform a clustering of behavior embeddings to compute the updated behavior state for that anchor. Instead, behavior state management may be performed using current behavior data (e.g., appearance and/or spatiotemporal data) extracted from the current behavior embeddings and the prior behavior state for that anchor, to update the prior behavior state based on the current behavior data. During propagation, incremental changes in either the appearance, location, and/or trajectory of a tracked subject may be incorporated into the behavior state data maintained for that anchor by the RTLS. In some embodiments, the updated behavior state data may comprise a statistically weighted fusion of prior and current appearance and spatiotemporal data. In some embodiments, the behavior state for a live anchor may represent a subject for a moving window of time. For example, the behavior state for a live anchor may represent appearance and spatiotemporal data based on behavior embeddings obtained over the last “t” seconds of time (e.g., over the last 5 or 10 seconds), so that trajectory and rendered tracking data may be computed based on period of recent movements by the subject.

In some embodiments, the set of current behavior embeddings from the current micro-batch may include one or more behavior embeddings not conforming to the continuity of trajectory predictions from the prior micro-batch. Those remaining behavior embeddings may represent subjects that are not present (e.g., not represented) in the most recent prior micro-batch of live streaming data. In some cases, one or more of those behavior embedding may be associated with dormant anchors—that is, previously initialized anchors that have not appeared in the most recent micro-batche(s) of live streaming data. For example, a subject having an initialized anchor may move to a location where they are temporarily not observable by the set of multiple camera views available to the RTLS (e.g., due to leaving the monitored area and/or due to an occlusion)—and after a period of time, the subject may return to a location where they are once again observable from the set of multiple camera views.

To identify whether the remaining behavior embeddings are associated with a dormant anchor, the RTLS may perform an assignment process that comprises the hierarchical clustering process followed by a matching algorithm. The hierarchical clustering process may evaluate the remaining behaviors (e.g., the behavior embeddings that could not be propagated as live anchors based on the continuity of trajectory analysis) to group the remaining behaviors into a set of one or more clusters based on the similarity of their behavior embeddings with each other. Distinct clusters may form from those remaining behavior embeddings that have not been associated with current live anchors. Once clustering is performed, the RTLS may execute a matching algorithm to determine if the clusters from the remaining behavior embeddings can be matched to (e.g., are similar to) behavior embeddings associated with a dormant anchor. If a cluster is determined to match with a dormant anchor, then the RTLS may perform behavior state management that re-classifies that dormant anchor as a live anchor, and the behavior state of the anchor updated based on the current behavior embeddings forming that cluster. If a cluster of remaining behavior embeddings cannot be matched to a dormant anchor, then that cluster may represent behaviors associated with a subject not previously observed by the RTLS, or that may have been previously associated with a dormant anchor that may have expired (e.g., that was deleted based on age and/or other data staleness criteria). In that case, the RTLS may initialize a new live anchor associated with that cluster, initialize a new global ID assigned to that new anchor, and initialize a behavior state for the new anchor based on the current behavior embeddings forming the cluster. Each cluster from the remaining behaviors that was not associated with a dormant anchor by the matching algorithm may similarly represent a new subject and be used to initialize a new anchor. In some embodiments, when the RTLS determines that the number of remaining behaviors remaining unmatched after execution of the matching algorithm exceeds a threshold (e.g., a ratio of unmatched to matched behavior embedding's), the RTLS may reinitialize (e.g., perform a system initialization as described above) to generate a new set of initialized anchors.

In some embodiments, the RTLS may comprise a machine learning model trained to perform the behavior detection and tracking, and to derive behavior embeddings. The machine learning model may comprise, for example, a re-identification (Re-ID) embedding model that encodes the appearance of each tracked subject. Optical image data comprising an image of a subject may be used to generate a bounding shape (e.g., box) for the subject, and crop the optical image data to the bounding shape. The Re-ID embedding model may output a behavior embedding for the cropped image that comprises an embedding vector. The behavior embedding may encode one or both of appearance data and spatiotemporal data (e.g., location and/or trajectory) that characterizes a subject. In some embodiments, the machine learning model may comprise a ResNet50 backbone architecture, or other deep neural network architecture.

In some embodiments, when clustering of behavior embeddings is performed by the RTLS, the RTLS performs a two-step hierarchical clustering process. As mentioned above, clustering may be performed on those behavior embeddings that are not found to be already associated with live anchors based on continuity of trajectory data. In the first step of the clustering process, the set of behavior embedding are clustered based on the similarity of their behavior embeddings. This first clustering is used to predict a number (e.g., a subject prediction number) representing how many clusters correlate with actual subjects represented by the behavior embeddings. The first-step of the clustering process may be based on applying a fine-tuned clustering threshold parameter to the behavior embeddings. That is, the clustering threshold parameter may define a criteria for how tightly clustered (e.g., how close in distance) a set of behavior embeddings need to be for that set of behavior embeddings to be considered a cluster. The clustering threshold parameter may, in some embodiments, comprise a clustering Quality Threshold (QT) specifying a threshold distance between members of the cluster and/or a minimum number of behavior embeddings that are to be within the threshold distance of each other for the set to be considered a cluster. In the second step of the clustering process, clustering is again performed using the set of behavior embedding and based on the similarity of their behavior embeddings and further based on constraining the clustering based on the subject prediction number derived from the first step of the clustering process. That is, the second step of the clustering process is constrained to cluster the behavior embeddings into a number of clusters that corresponds to the number of subjects that are predicted to be present in the micro-batch of live streaming data. Since each cluster produced from the second step of the clustering process are expected to comprise behavior embeddings representative of the same distinct subject, the appearance data and/or the spatiotemporal data encoded in the behavior embeddings with each cluster should be highly similar—and readily distinguishable from the appearance data and the spatiotemporal data provided by the behavior embeddings of other clusters that represent other distinct subjects within the monitored area. Advantageously, using the two-step clustering the processes of initializing new anchors from the resulting clusters and/or reclassifying dormant anchors as live anchors both may benefit from a high degree of confidence that the behavior embeddings of each cluster correspond to a distinct subject distinguishable from other subjects.

In some embodiments, when the RTLS performs the two-step hierarchical clustering process, the process may use ReID appearance data from the behavior embeddings without integrating spatiotemporal data. The spatiotemporal information may be subsequently incorporated in the re-assignment phase through matching process, where both spatiotemporal and ReID distances may be normalized and weighted for decision-making. At each iteration of the matching processes, the appearance data and spatiotemporal data (e.g., locations) of the clusters may be updated and optimized.

As discussed above, in some embodiments the clustering process may be followed by a matching process to determine if the behavior embeddings associated with a cluster match with (e.g., are similar to) behavior embeddings associated with a previously initialized live anchor that has since been classified as a dormant anchor. In some embodiments, the matching may be performed using an iterative matching combinatorial optimization algorithm (e.g., a matching algorithm that solves an assignment problem by matching agents to tasks). In some embodiments, the matching process may apply a Hungarian matching algorithm, which may be referred to as a Kuhn-Munkres algorithm or a Munkres assignment algorithm, to assign a cluster produced by the clustering process to currently dormant anchors, by matching behavior embeddings of a cluster to previously initialized behavior states associated with the dormant anchors (e.g., based on similarity). In some embodiments, iterative refinement may include sufficient iterations to obtain an optimal matching accuracy saturation (e.g., approximately 10 iterations in the case of a Hungarian matching algorithm). If a cluster is assigned (matched) to a prior behavior state of a dormant anchor, then the RTLS may reclassify that dormant anchor as a live anchor, and apply behavior state management to update the behavior state of that now live anchor based on the appearance data and the spatiotemporal data provided by the current behavior embeddings from the cluster. If the matching algorithm determines that a cluster cannot be assigned (matched) to a dormant anchor, then a new live anchor may be initialized for that cluster, with its initial behavior state defined based on the appearance data and the spatiotemporal data provided by the current behavior embeddings from the cluster.

As discussed above, the RTLS may apply state management to update the behavior state of live anchors based on appearance data and/or spatiotemporal data provided by current behavior embedding associated with the live anchors. For example, in some embodiments, the RTLS may determine the current behavior embeddings associated with a live anchor from the current micro-batch of live streaming data, and prior behavior embeddings as represented by a prior behavior state of the live anchor, and update the behavior state of the live anchor based on the current behavior embeddings. In this way, the behavior state of the live anchor may be updated based on current appearance data for the subject, and/or based on the current location and/or trajectory data for the subject. In some embodiments, updating may comprise a fusing or stitching of behaviors represented by current and prior/historical behavior embeddings for the anchor. The behavior state for an anchor may thus comprise both current and historical behavior data. In some embodiments, the appearance data and/or spatiotemporal data provided by current behavior embeddings may be weighed differently than appearance data and/or spatiotemporal data from the behavior state representing prior behavior embeddings. As an example, a set of historical appearance, location and/or trajectory data for a live anchor may be considered more reliable than the most recent appearance, location and/or trajectory data. In some embodiments, when the behavior state is updated, the historical appearance, location and/or trajectory data may be given a higher weighting (e.g., 0.9) while the current appearance, location and/or trajectory data is given a relatively lower weighting (e.g., 0.1), as the data is combined to update the behavior state for the live anchor. Conversely, when the RTLS is updating a behavior state of a dormant anchor that has been reclassified as a live anchor, the current appearance, location and/or trajectory data may be more accurate than the historical appearance, location and/or trajectory data, depending on how long the anchor was a dormant anchor. In such a case, the historical appearance, location and/or trajectory data may be given a lower weighting (e.g., 0.1) while the historical appearance, location and/or trajectory data is given a relatively higher weighting (e.g., 0.9), as the data is combined to update the behavior state for the anchor. In some embodiments, a behavior state may maintain historical appearance data and/or spatiotemporal data for a predetermined duration, and purge historical data from the behavior state based on age and/or other data staleness criteria. For example, in some embodiments, a behavior state may maintain the prior 5 or 10 seconds of historical appearance, location and/or trajectory data for a live anchor.

In some embodiments, the RTLS may use a configurable state retention time for determining the duration a dormant anchor can remain eligible for reclassification back to being a live anchor instead of the RTLS initializing a new anchor. If a dormant anchor has remained dormant for longer than the state retention time, then it may expire. For example, given a configurable state retention time of 10 minutes, the RTLS would trigger initialization of a new anchor for a tracked subject reappearing 15 minutes after becoming dormant. After an anchor has been dormant for longer than the configurable state retention time, the RTLS may delete the expired dormant anchor (e.g., so that it cannot be reactivated as a live anchor). In some embodiments, historical behavior data and/or behavior states associated with a deleted anchor may be maintained in a database for later analysis (e.g., using a QBE functionality as described below).

Subject tracking data derived from behavior states of live anchors may be used as input, for example, by one or more subject evaluation systems. Subject tracking data may be used by a rendering system to display a comprehensive view of the monitored area and visually render location and trajectory tracking data for each subject in the area, where the rendering system may benefit from having a real-time spatiotemporal understanding of the location and movements of subjects of interest within the monitored area. This may include switching between real and/or virtual camera views while tracking a subject moving through the area to locate a current position of a specific subject within the area (e.g., based on a global ID or other query).

In some embodiments, the RTLS may use the behavior states of live anchors to render a user interface (UI) on a human machine interface display. The UI may present a comprehensive computer vision-based view of the monitored area and/or views of selected portions of the monitored area. For example, the RTLS may use the location and/or trajectory data for each live anchor to display a predicted location and/or tracking information associated with each subject. In some embodiments, the RTLS may generate a computer-vision based display of a top-down (birds-eye) view of the monitored area—displaying the location and/or tracking of each tracked subject. The RTLS may generate a display of a computer-vision based environment corresponding to a viewpoint of one or more of the real image sensors providing the real-time live streaming data, and/or of a viewpoint of one or more virtual camera views instantiated within the computer-vision based environment. In some embodiments, a subject may be selected via the user interface and their movements tracked through the computer-vision based environment based on the behavior state of the subject's associated anchor. A global ID (or other corresponding identifier) may be displayed for one or more of the subjects tracked through the monitored area by the RTLS.

In some embodiments, the RTLS may generate an output representing data from the behavior states of the one or more of the subjects being tracked in the monitored area. The output may be used as input for other systems. For example, in some embodiments, a navigation control system for a mobile machine, such as an automated mobile robot (AMR) and/or an ego-machine, may dynamically route the mobile machine away from using a path that may be congested by the presence of tracked subjects (e.g., people, obstacles) on the path. In some embodiments, the RTLS implements an RTLS application programming interface (API) to facilitate an AMR integration for communicating tracked subject movements to an AMR control system, and/or display tracked subjects relevant to an AMR on a user interface (UI) as described below. In some embodiments, the output from the RTLS may be used by a security system to track a person of interest in real time as they traverse through the monitored area.

In some embodiments, the RTLS may integrate query by example (QBE) functionality, utilizing global IDs and behavior embeddings produced by the RTLS and stored in a database (e.g., a Milvus database, vector database, and/or other vector database management system (VDBMS)) to support long-term QBE queries spanning over selected time periods. The QBE functionality may operate based on representational state transfer (REST) application programming interface (API) inputs, that may include one or more of, but not limited to, an object ID, a sensor ID, a timestamp, optional parameters like time range, match score threshold, and/or top K matches, for obtaining similar behaviors. The QBE functionality may normalizes the behavior embeddings before searching in the database for similar ones, and the matched behaviors may have IDs used by the REST API to fetch behavior metadata using a search engine (e.g., Elasticsearch). This search capability of the QBE functionality may provide for precise and efficient retrieval of relevant tracked subject behavior patterns over extended periods.

Because the RTLS initializes live anchors for each subject of interest, and updates behavior states of live anchors from micro-batch to micro-batch based on tracking trajectory continuity, the execution of complex clustering and/or matching algorithms may be limited to just those instances where a micro-batch of live streaming data comprises behavior embeddings not already associated with live anchors, and/or computationally limited to apply the clustering and/or matching algorithms just to those embeddings not already associated with live anchors. As such the RTLS may process each micro-batch of live streaming data quickly enough to support real-time multi-camera multi-subject tracking applications in high-density environments, for example where the location and trajectory tracking data for multiple subjects may be simultaneously computed and/or displayed within a short period (e.g., within one second or less) of the micro-batch of live streaming data being captured.

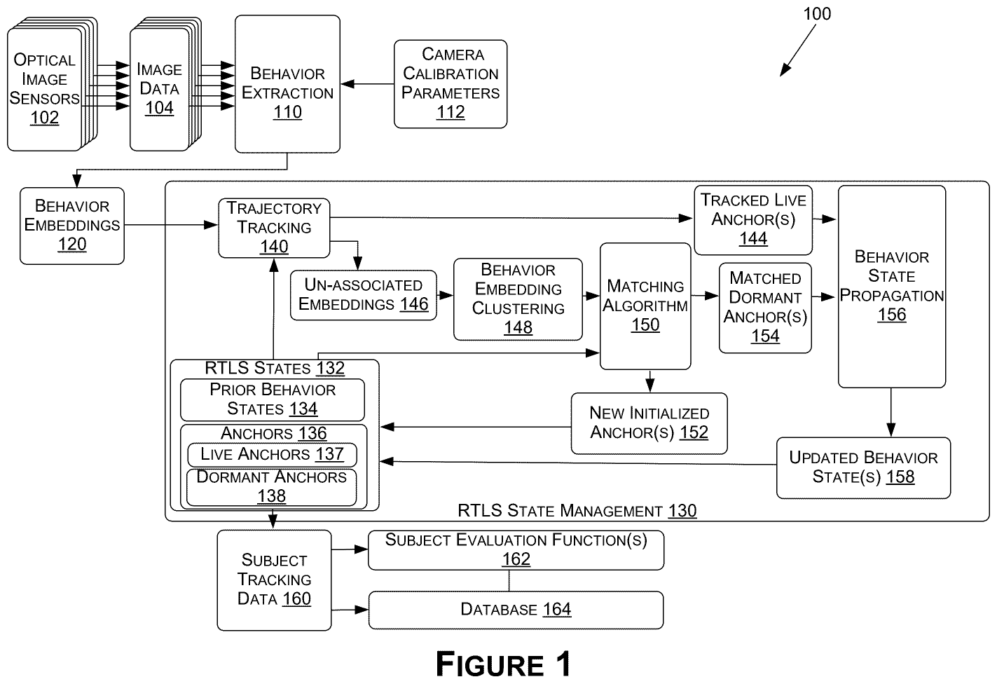

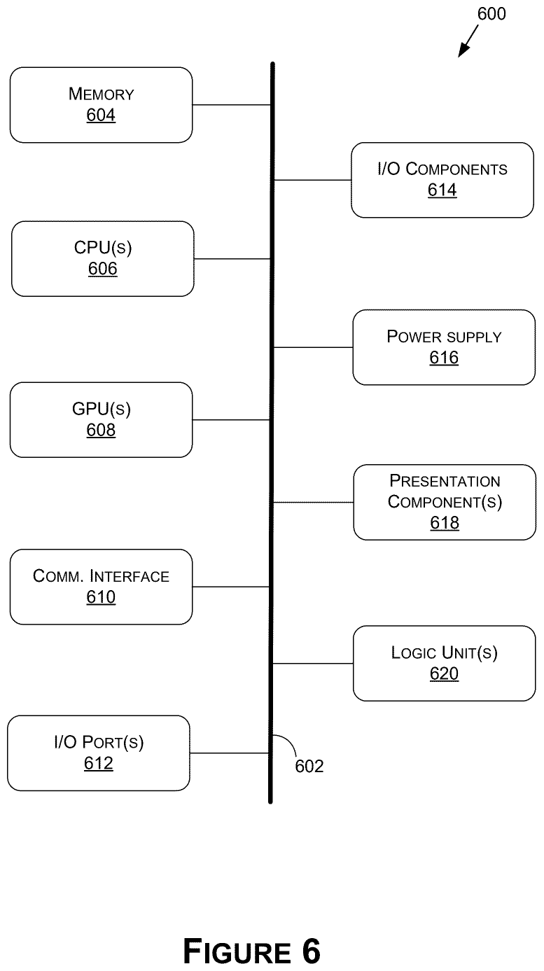

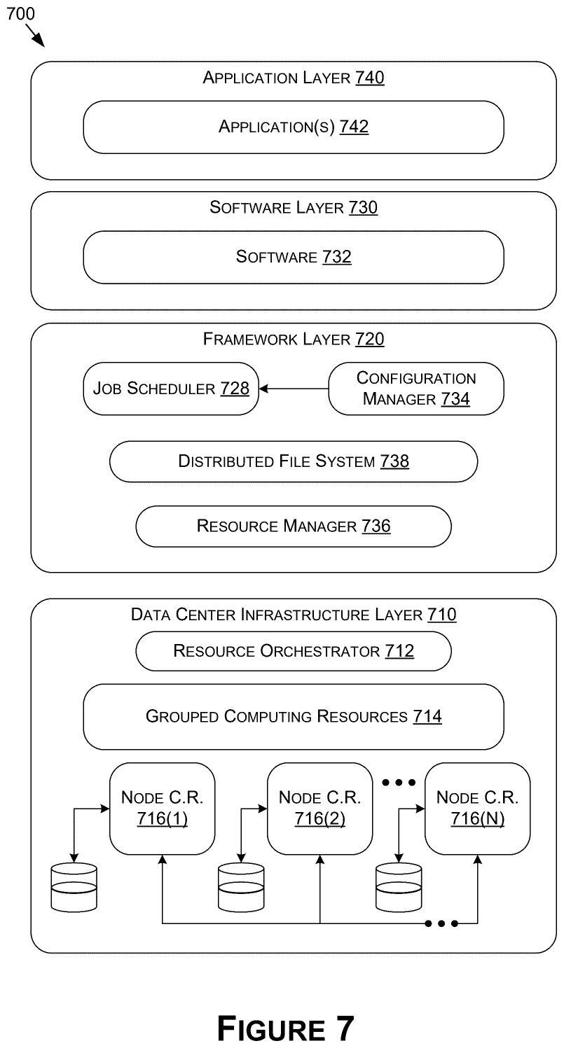

FIG. 1 is an example data flow diagram for a real-time location system (RTLS) 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors (e.g., processing units, processing circuitry) executing instructions stored in memory. In some embodiments, the systems, methods, and processes described herein may be executed using similar components, features, and/or functionalities to those of example computing device 600 of FIG. 6, and/or example data center 700 of FIG. 7.

As shown in FIG. 1, the RTLS 100 may receive image data 104 from a plurality of optical image sensors 102 (e.g., cameras) to track the location and trajectory of a plurality of subjects within a monitored area based on initializing anchors assigned to individual tracked subjects and updating behavior states for those anchors based on behavior data extracted from the image data 104. In some embodiments, the image data 104 includes synchronized optical image streaming data based on live-streaming feeds from the plurality of optical image sensors 102. In some embodiments, the image data 104 includes synchronized optical image streaming data based on batches of previously recorded live-streaming feeds from the plurality of optical image sensors 102.

The image data 104 may include individual video image feeds that are synchronized such that the streaming data comprises individual image feeds from distinct optical images sensors 102 that capture image data at the same time. The video image feeds may include timestamps that can be used to align contemporaneously captured image data from the multiple feeds. The RTLS 100 may process the image data 104 as sequential micro-batches, for example where each micro-batch defines a distinct sub-second time frame of the image data 104. In some embodiments, the optical image sensors may comprise, for example, one or more RGB cameras, one or more IR cameras, one or more RGB-IR cameras, and/or one or more cameras as discussed with respect to computing device 600 discussed below.

The image data 104 may be processed using behavior extraction 110 to extract behavior embeddings 120 that represent individual behaviors of tracked subjects represented in the image data 104. That is, each behavior embedding 120 may comprise a representation of a tracked subject as appearing in an individual feed of image data 104 associated with a distinct one of the optical image sensors 102. The representation provided by a behavior embeddings 120 may comprise behavior data that includes appearance data (e.g., characterizing the appearance of the tracked subject) and/or spatiotemporal data (e.g., characterizing the location and/or trajectory of the tracked subject with respect to the monitored area. As discussed herein, each of the optical image sensors 102 may capture image data 104 based on their particular view of the monitored area, which is at least in part a function of the extrinsic camera calibration parameters 112 (e.g., one or more rotation-translation transforms) associated with each of the individual optical image sensors 102. Accordingly, the spatiotemporal data represented by behavior embeddings 120 may be mapped, using the camera calibration parameters 112, to a global coordinate system associated for the monitored area—thus facilitating the correlation of spatiotemporal data from the behavior embeddings 120 for clustering, matching, trajectory tracking, and/or other purposes.

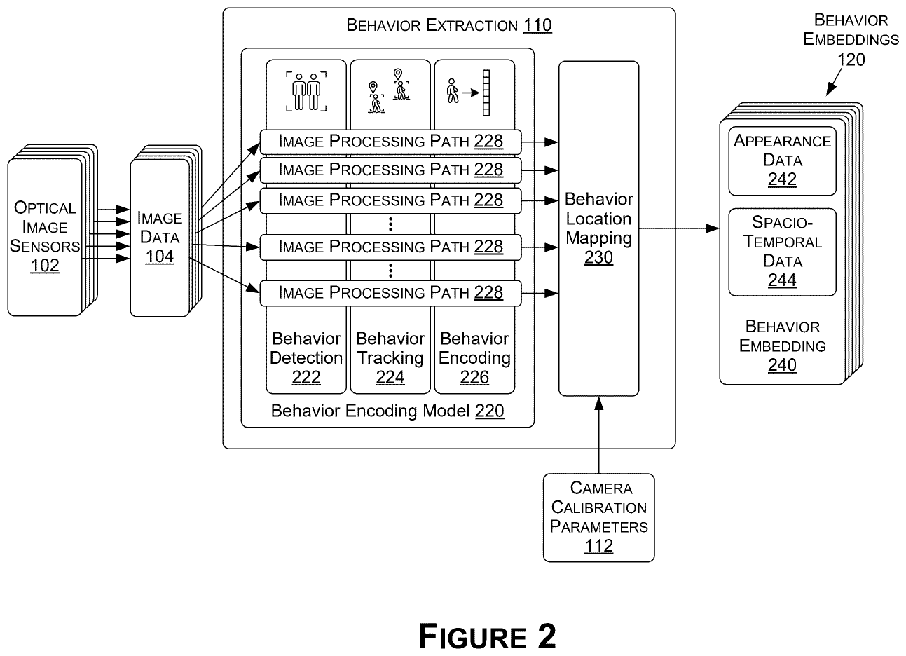

FIG. 2 is a data flow diagram illustrating the operation of behavior extraction 110 for a process to extract behavior embeddings 120 from the image data 104. As shown in FIG. 2, the behavior extraction 110 may implement a plurality of parallel data processing paths 228, where each path 228 may independently process a feed of the image data 104 associated with one of the optical image sensors 102. Within each path 228, the behavior extraction 110 may perform behavior detection 222, behavior tracking 224 and/or behavior encoding 226. The behavior detection 222 may function to recognize and extract features corresponding to behaviors for tracked subjects as observed in each processing path 228 (e.g., people, vehicles, machines, animals, and/or other subjects of interest). In some embodiments, optical image data 104 comprising an image of a subject may be used by the behavior detection 222 to generate a bounding shape (e.g., box) for one or more subjects, and for each subject produce subject specific optical image data cropped to the bounding shape. Behavior tracking 224 may function to compute spatiotemporal characteristics associated with each detected behavior associated with a tracked subject, such as location and trajectory (speed, and direction of movement) with respect to the local image frame of a sensor that captured the image data. Behavior encoding 226 may generate encodings of the appearance and spatiotemporal data associated with each of the behaviors detected from the image data, which are used to produce the behavior embeddings 120. Also as shown in FIG. 2, as each of the processing paths 228 is associated with a different optical image sensor 102 that may capture image data 104 based on their particular view of the monitored area, in some embodiments the behavior extraction 110 may further include behavior mapping 230 that applies the camera calibration parameters 112 to map the spatiotemporal data associated with each behavior to the global coordinate system associated with the monitored area. The resulting output from the behavior extraction 110 may comprise a plurality of behavior embeddings 120, where each individual behavior embedding 240 may comprise behavior data (e.g., appearance data 242 and/or spatiotemporal data 244) representing a tracked subject as that tracked subject appears in an individual feed of image data 104 associated with a distinct one of the optical image sensors 102.

In some embodiments, one or more of the behavior detection 222, behavior tracking 224 and/or behavior encoding 226 may be performed by the behavior extraction 110 using a behavior encoding model 220 (e.g., a machine learning model). The behavior encoding model 220 may comprise, for example, a re-identification (Re-ID) embedding model that encodes the appearance of each tracked subject appearing in the image data 104 carried by the processing paths 228. In some embodiments, based on the optical image data 104 comprising an image of a tracked subject, the behavior encoding model 220 may generate a bounding shape (e.g., box) around a detected behavior and crop the optical image data to the bounding shape. For example, an image of a detected behavior for a subject may be cropped and the cropped images resized, for example, to a 256×128 pixel image. The behavior encoding model 220 may output a behavior embedding 240 corresponding to the cropped image. In some embodiments, a behavior embedding 240 may be structured in the form of an embedding vector. The embedding vector may comprise, for example a vector with a dimension that is configurable in size from 1 to 2048 elements. In some embodiments, an embedding vector may have a default size of 256. A behavior embedding 240 computed by the behavior encoding model 220 may encode one or both of appearance data 242 and spatiotemporal data 244 that characterizes a tracked subject. In some embodiments, the behavior encoding model 220 may comprise a ResNet50 backbone architecture, or other deep neural network (DNN) architecture. The behavior encoding model 220 may be trained with a combination of triplet loss, center loss and ID loss (e.g., cross entropy loss). Re-ID features may be used to compute the triplet loss, which minimizes the embedding distance of behaviors associated with the same subject (positive samples), while maximizing the distance of other behaviors associated with the different subjects (negative samples).

Returning to FIG. 1, as shown in FIG. 1, the RTLS 100 may comprise an RTLS state management 130 that produces and maintains anchors (and their corresponding behavior states) for tracking subjects that are observable within the monitored area based on behavior embeddings 120 produced from sequences of image data 104 over a series of time frames. More particularly, the RTLS state management 130 assigns clusters of behavior embeddings 120 to anchors, where each anchor represents a distinct tracked subject within the monitored area. Each anchor has a corresponding behavior state wherein behavior data for the distinct tracked subject may be maintained, associated with a global ID, and tracked over time. In some embodiments, the RTLS state management 130 may include RTLS states 132 that comprise one or more anchors 136 and corresponding prior behavior states 134 associated with tracked subjects. As discussed above, anchors 136 maintained by the RTLS states 132 may include live anchors 137 and dormant anchors 138. At each iteration of the operation of RTLS state management 130, the RTLS states 132 may be updated to reflect newly initialized anchors and/or current behavior data derived from the current time frame of behavior embeddings.

In some embodiments, when a set of behavior embeddings 120 is received by the RTLS state management 130, the RTLS state management 130 performs trajectory tracking 140. In some embodiments, the trajectory tracking 140 may use a continuity of trajectory analysis to associate prior behavior states 134 and live anchors 137 from previous time frames with the behavior embeddings 120 derived from the current micro-batch of live streaming data, to identify tracked live anchors 144 that may be propagated forward as live anchors 137 and updated.

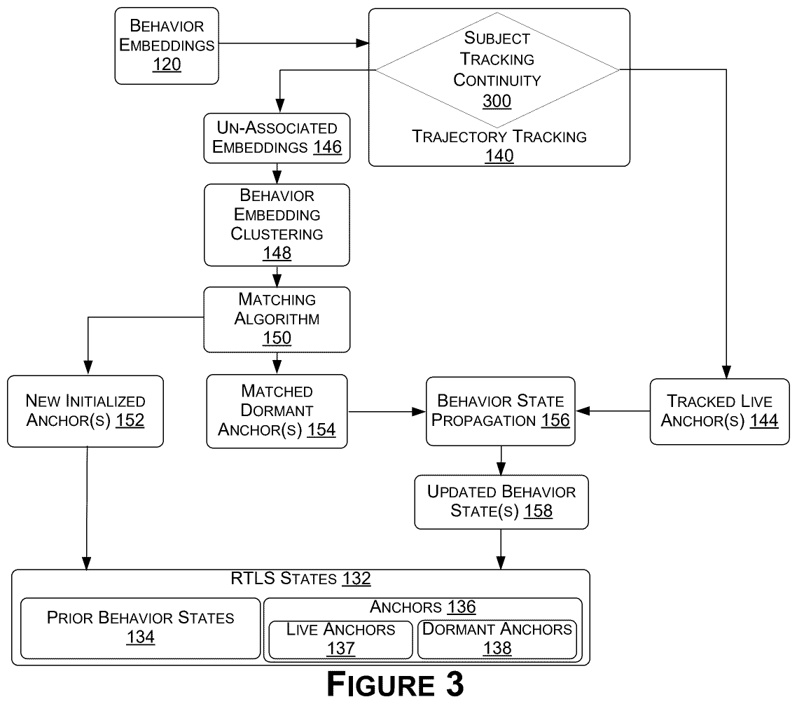

For example, with further reference to FIG. 1, FIG. 3 is a data flow diagram illustrating operation of the RTLS state management 130, in accordance with some embodiments. The trajectory tracking 140 may perform a trajectory analysis, such as subject tracking continuity 300, based on the behavior data included in behavior embeddings 120. For each prior behavior state 134 associated with a live anchor 137, the trajectory tracking 140 may use prior location and trajectory data (e.g. direction vectors) to compute a predicted (e.g., expected) current location and trajectory (direction of motion) given the elapsed time between iterations—and assess tracking continuity based on the predicted current location and trajectory. If the magnitudes of the direction vectors indicate movement in tracked subjects, the trajectory tracking 140 may normalize the direction vectors and compute the difference between their angles. This normalized angle difference is then used as a factor to adjust the final spatiotemporal distance calculation. Behavior embeddings 120 that include location and trajectory data within a threshold distance (e.g., a Euclidean distance) of an expected current location and trajectory computed from a prior behavior state 134 for a live anchor 137 from the preceding time frame (e.g. the immediate prior micro-batch of image data 104) may be assigned to the anchor 136 for that prior behavior state 134 and used to define a set of tracked live anchor(s) 144. The tracked live anchor(s) 144 may then be processed using behavior state propagation 156 to update the prior behavior state(s) 134. That is, the behavior state propagation 156 may generate updated behavior states 158 associated with the tracked live anchor(s) 144 that include the corresponding current behavior data from the behavior embeddings 120. In some embodiments, a similarity in appearance data from the behavior embeddings 120 may be used to further validate an association between the behavior embeddings 120 and a tracked live anchor(s) 144. Because the RTLS 100 updates at least a portion of the prior behavior states 134 of live anchors 137 based on tracking trajectory continuity, the execution of complex clustering and/or matching algorithms may be avoided at least for the tracked live anchor(s) 144.

In some embodiments, the trajectory tracking 140 may identify one or more of the behavior embeddings 120 that do not have a tracking continuity with a prior behavior state(s) 134 associated with a live anchor 137. Those remaining behavior embeddings may be classified by the trajectory tracking 140 as un-associated embeddings 146 that represent subjects detected by the behavior extraction 110 that are not associated with a live anchor 137. For example, the un-associated embeddings 146 may represent behaviors captured in the current time frame of image data 104 that were not present in the prior micro-batch of image data 104. In some cases, one or more of those behavior embeddings may be associated with anchors 136 that have be reclassified as dormant anchors 138. A dormant anchor 138 (and its corresponding prior behavior state 134) may represent a subject previously observable by the optical image sensors 102, but that was not observable in a most recent prior time frame of image data 104 (e.g., due to leaving the monitored area and/or due to an occlusion). To determine whether one or more of the un-associated embeddings 146 can be associated with a dormant anchor 138 (e.g., in the case where the subject has returned to the monitored area or is otherwise once again observable by the optical image sensors 102), the RTLS state management 130 may selectively apply an assignment process that comprises behavior embedding clustering 148 followed by one or more matching algorithms 150.

Behavior embedding clustering 148 may perform a clustering of the un-associated embeddings 146 based on similarity of behavior data (e.g., appearance data and/or spatiotemporal data). As such, behavior embeddings that comprise representations of the same person within the same time frame should share similar behavior data so that those behavior embeddings would form a cluster that can be uniquely associated with a distinct subject. Other distinct clusters may form in the same way based on behavior embeddings associated with other subjects represented in the un-associated embeddings 146. In some embodiments, the behavior embedding clustering 148 may apply one or more hierarchical clustering algorithms such as, but not limited to, a balanced iterative reducing and clustering using hierarchies (BIRCH) algorithm, a Ordering points to identify the clustering structure (OPTICS) algorithm, a Density-based spatial clustering of applications with noise (DBSCAN), a hierarchical DBSCAN (HDBSCAN*), an agglomerative clustering algorithm, and/or other clustering algorithms.

In some embodiments, behavior embedding clustering 148 performs a two-step hierarchical clustering process. As mentioned above, the clustering process may be performed on the un-associated embeddings 146 that were not found to be already associated with live anchors 137 based on the trajectory tracking 140. In the first step of the clustering process, the behavior embedding clustering 148 may cluster the un-associated embeddings 146 based on, for example, a similarity of behavior data. This first step of the clustering process may generate a number if clusters used to determine a subject prediction number. The subject prediction number represents how many clusters produced from the un-associated embeddings 146 correlate with actual subjects. The first-step clustering may be based on applying a fine-tuned clustering threshold parameter to the un-associated embeddings 146—to define how tightly clustered a set of behavior embeddings may need to be (e.g., how close in distance) to be considered a cluster. The clustering threshold parameter may, in some embodiments, comprise a clustering Quality Threshold (QT) specifying a threshold distance between members of the cluster and/or a minimum number of behavior embeddings that are to be within the threshold distance of each other for the set to be considered a cluster.

In some embodiments, in the second step of the clustering process, behavior embedding clustering 148 performs a second clustering of the un-associated embeddings 146 that comprises a constrained clustering of the un-associated embeddings 146 based on the subject prediction number derived from the first step of the clustering process. That is, the behavior embedding clustering 148 constrains the clustering process to cluster the behavior embeddings into a number of clusters that corresponds to the number of subjects that are predicted to be present in the un-associated embeddings 146. As such, since each cluster produced by the behavior embedding clustering 148 from the second step of the clustering process are expected to comprise behavior embeddings representative of the same distinct subject. Both the appearance data and/or the spatiotemporal data encoded in the behavior embeddings within each cluster should be highly similar—and readily distinguishable from the appearance data and the spatiotemporal data provided by the behavior embeddings of other clusters that represent other distinct subjects within the monitored area. In some embodiments, when the behavior embedding clustering 148 performs the behavior embedding clustering 148, the process may use ReID appearance data from the un-associated embeddings 146 without integrating spatiotemporal data. The spatiotemporal information may be subsequently incorporated in a re-assignment phase by the matching algorithm 150, where both spatiotemporal and ReID distances may be normalized and weighted for decision-making. At each iteration of the matching algorithm 150, the appearance data and/or spatiotemporal data (e.g., locations) of the clusters may be updated and optimized.

The clusters produced by the behavior embedding clustering 148 may be used as input to the matching algorithm 150 to determine whether one or more of the clusters match with a prior behavior state 134 associated with a dormant anchor 138 (e.g., a previously initialized live anchor that has since been re-classified as a dormant anchor). A live anchor 137 may have been re-classified as a dormant anchor 138, for example, because the subject for that anchor stopped appearing in one or more time frames of image data 104 for at least a threshold duration of time. In some embodiments, the matching algorithm 150 may use an iterative matching combinatorial optimization algorithm (e.g., a matching algorithm that solves an assignment problem by matching agents to tasks) to associate a cluster to a dormant anchor 138. As an example, the matching algorithm 150 may apply to the clusters a Hungarian matching algorithm, which may be referred to as a Kuhn-Munkres algorithm or a Munkres assignment algorithm. The matching algorithm 150 may assign a cluster produced by the behavior embedding clustering 148 to currently dormant anchors 138, by matching behavior embeddings of the cluster to behavior data represented by prior behavior states 134 associated with dormant anchors 138 (e.g., based on similarity). The output from the matching algorithm 150 may comprise a set of matched dormant anchors 154 (e.g., a set of one or more dormant anchors 138 that were successfully matched to a cluster produced by the behavior embedding clustering 148). The matched dormant anchors 154 may then be processed by the behavior state propagation 156 to update the prior behavior state(s) 134. For example, the behavior state propagation 156 may reclassify as live anchors 137, the dormant anchors 138 included in the matched dormant anchors 154. Moreover, the behavior state propagation 156 may generate one or more updated behavior states 158 associated with the matched dormant anchors 154. Based on the updated behavior states 158, the prior behavior states 134 associated with the matched dormant anchors 154 may be updated to include the corresponding current behavior data based on the behavior embeddings 120 represented by the assigned clusters. In some embodiments, iterative refinement performed by the matching algorithm 150 may include sufficient iterations to obtain an optimal matching accuracy saturation (e.g., approximately 10 iterations in the case of a Hungarian matching algorithm).

When the matching algorithm 150 determines that one or more clusters produced by the behavior embedding clustering 148 cannot be assigned (matched) to a dormant anchor 138, then the RTLS state management 130 may update the RTLS states 132 to include one or more new initialized anchors 152, each corresponding to an un-matched cluster. Moreover, for each of the new initialized anchors 152, the RTLS state management 130 may update the RTLS states 132 to include an associated new behavior state that will define one of the prior behavior states 134 for processing the next time frame of image data 104. In some embodiments, each new behavior state may include a representation of behavior data associated with a distinct tracked subject based on behavior embeddings from the clusters.

In some embodiments, the RTLS state management 130 may use a configurable state retention time, for determining the duration a dormant anchor 138 can remain eligible for reclassification back to being a live anchor 137. For example, given a configurable state retention time of 10 minutes, the RTLS state management 130 would trigger initialization of a new initialized anchor 152 for a tracked subject reappearing 15 minutes after becoming dormant. After an anchor has been dormant for longer than the configurable state retention time, the RTLS state management 130 may delete the dormant anchor from the listing of dormant anchors 138 such that it cannot be reactivated as a live anchor 137. In some embodiments, the RTLS state management 130 may maintain in the RTLS states 132 historical behavior data and/or behavior states associated with a deleted anchor 136 in a database for later analysis (e.g., using a QBE functionality).

Returning to FIG. 1, the RTLS states 132 may be updated to include new anchors 136 based on the new initialized anchors(s) 152, and/or to update the prior behavior states 134 based on the updated behavior states.

Subject tracking data 160 derived from the RTLS states 132 and/or behavior data represented by prior behavior states 134 may be used as input, for example, by one or more subject evaluation functions 162 (e.g., analytics, query, and/or rendering systems). For example, the subject evaluation function(s) 162 may comprise a query by example (QBE) functionality, utilizing global IDs and behavior embeddings produced by the RTLS 100. Behavior embeddings and/or other behavior data associated with one or more tracked subjects may be stored in a database 164 (e.g., a Milvus database, vector database, and/or other vector database management system (VDBMS)) to support long-term QBE queries spanning over selected time periods. In some embodiments, the QBE functionality may operate based on representational state transfer (REST) application programming interface (API) inputs, that may include one or more of, but not limited to, an object ID, a sensor ID, a timestamp, optional parameters like time range, match score threshold, and/or top K matches, for obtaining similar behaviors. The QBE functionality may normalize the behavior embeddings before searching in the database 164 for similar behavior embeddings, and the matched behaviors may have IDs used by the REST API to fetch behavior metadata using a search engine (e.g., Elasticsearch). This search capability of the QBE functionality may provide for precise and efficient retrieval of relevant tracked subject behavior patterns over extended periods. In some embodiments, the subject tracking data 160 may be generated based on queries performed using the QBE functionality. In some embodiments, the one or more subject evaluation functions 162 may use subject tacking data 160 (and/or other data from the RTLS 100 representing behavior data) to control the operation of one or more machines and/or systems. For example, the subject evaluation functions 162 may control one or more operations of an AMR and/or an ego-machine, based on the location of the one or more of the tracked subjects as represented by the subject tracking data 160.

In some embodiments, the one or more subject evaluation functions 162 may include a rendering system to display via a UI a comprehensive view of the monitored area and visually render location and trajectory tracking data for each subject in the area as indicted by the subject tracking data 160. The rendering system may permit a user to switch between real and/or virtual camera views while tracking a subject moving through the monitored area, to locate a current position of a specific subject within the area (e.g., based on their global ID), and/or other applications that may benefit from having a real-time spatiotemporal understanding of the location and movements of subjects of interest within the monitored area.

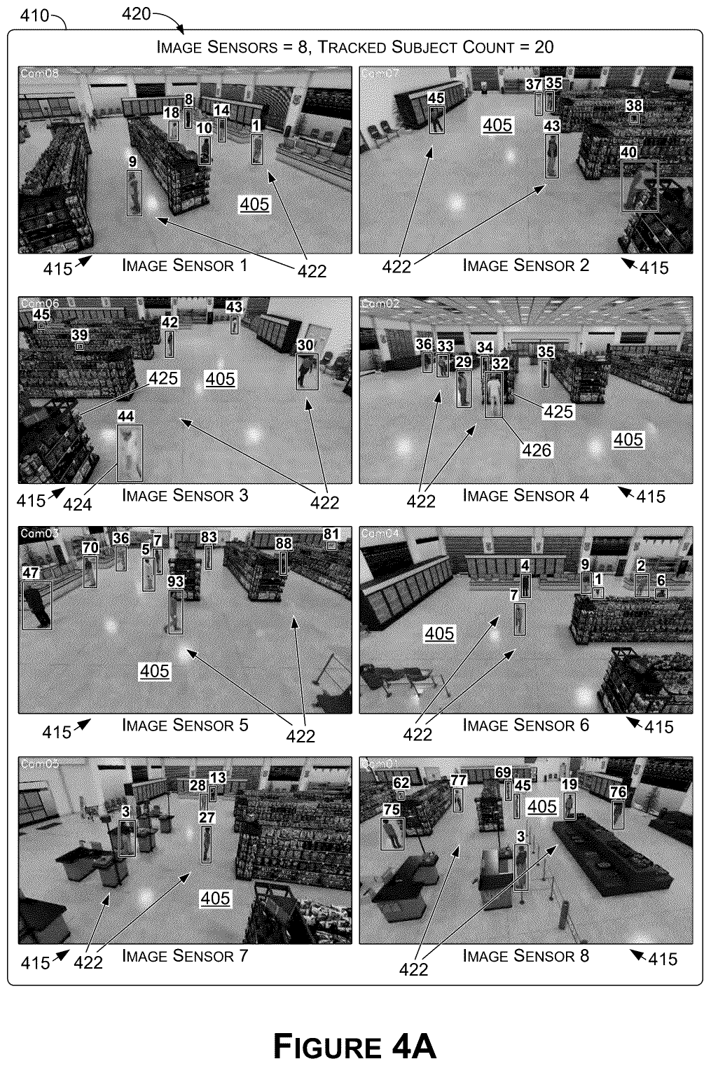

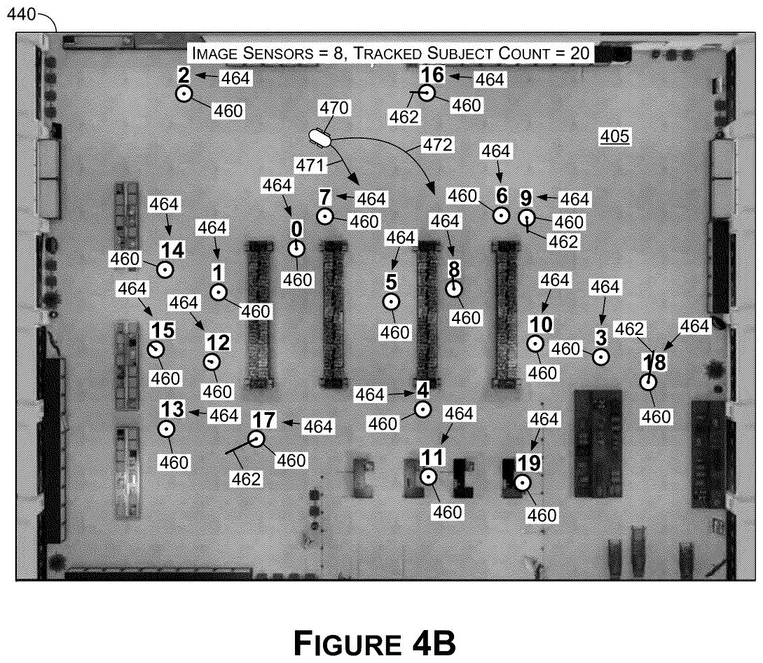

For example, FIGS. 4A and 4B are diagrams that illustrate example UIs that may be displayed using a human machine interface coupled to the RTLS 100 (e.g., one or more of the presentation components 618 of example computing device(s) 600). In the examples of FIGS. 4A and 4B, the RTLS 100 may include a set of optical image sensors 102 that comprise eight cameras arranged to view different portions of a monitored area 405 (e.g., an environment). Here, the monitored area 405 is depicted in the form of a grocery store, but it should be appreciated that in various embodiments, the monitored area 405 may comprise any area where subject tracking is desired such as, but not limited to, warehouses, factories, retail establishments, hospitals, office buildings, secured facilities, arenas, public transportation stations, parks, public spaces, and the like. In FIG. 4A, a UI display 410 presents a plurality of views 415 of the monitored area 405, referenced as Image Sensors 1-8. In some embodiments, each of the views 415 may corresponds to an image feed from a distinct one of the optical image sensors 102. In some embodiments, the RTLS 100 may generate one or more of the views 415 as a display of a computer-vision based environment corresponding to a viewpoint of one or more of the optical image sensors 102, and/or of a viewpoint of one or more virtual camera views instantiated within the computer-vision based environment.

As shown in FIG. 4A, each of the views 415 may present a plurality of behaviors 422 each corresponding to a tracked subject within the view of the respective optical image sensor 102. Moreover, for each of the behaviors 422, the RTLS 100 may extract behavior data and generate a corresponding one of the behavior embedding 120. Across the eight image sensors, 20 tracked subjects are present and observable within the monitored area 405, so that up to 160 behavior embeddings 120 may be expected to be generated by the behavior extraction 110. However, in reality the number of behavior embeddings 120 may be expected to be fewer since each of the 20 tracked subjects are not likely to be observable by all 8 image sensors at the same time. In this example, six behaviors are observable from images sensor 1, six behaviors are observable from image sensor 2, six behaviors are observable from image sensor 3, six behaviors are observable from image sensor 4, nine behaviors are observable from image sensor 5, six behaviors are observable from image sensor 6, five behaviors are observable from image sensor 7, and eight behaviors are observable from image sensor 8. As such, in total, the behavior extraction 110 processing these image feeds may detect 52 distinct behaviors 422 and accordingly generate 52 behavior embeddings 120. In other embodiments, the RTLS 100 may obtain image data 104 from a greater or fewer number of optical image sensors 102 and display views for one or more view from that image data as illustrated in FIG. 4A

As discussed herein, similarities between the behaviors 422 may be used to associate behaviors to individual tracked subjects. For example, image sensor 3 captures a behavior 424 located at an isle end cap 425 that is similar in appearance to a corresponding behavior 426 captured by image sensor 4 located at the isle end cap 425. As such, behavior emeddings for behavior 424 and behavior 426 would be similar with respect to appearance data and/or spatiotemporal data, and will cluster together based on similarity. The behavior embeddings for behavior 424 and behavior 426 may therefore both be assigned to the same anchor, behavior state, and/or global ID. In some embodiments, the RTLS 100 may display a global ID (or other individual identifier) assigned to an anchor for a tracked subject, next to their behaviors as displayed in one or more of the views 415. In some embodiments, UI display 410 may include an information field 420 displaying information about observed tracked subjects, such as the number of tracked subjects presented across the multiple views 415 and/or the number of optical image sensors 102 contributing optical image data 104 to the RTLS 100 to produce the views 415.

FIG. 4B is an example UI display 440 presenting a top down view of the monitored area 405. In some embodiments, the UI display 440 presents virtual subjects 460 at the positions of individual tracked subjects corresponding to the anchors produced by the RTLS 100, and based on the behavior data represented by the behavior states corresponding to those anchors. Each of the 52 behavior embeddings 120 produced from the multiple image sensor data feeds illustrated in FIG. 4A are clustered and associated with a live anchor 137 by the RTLS sate management 130, and rendered as a virtual subject 460 in FIG. 4B. The spatiotemporal data for each behavior 424 from the views 415 has been mapped to a global coordinate system of the monitored area 405 so that the position of tracked subjects may be presented using the virtual subjects 460 with respect to a common frame of reference within the UI display 440.

As the RTLS states 132 are updated, the RTLS 100 may update the position and/or appearance of each virtual subject 460 representation of a tracked subject within the UI display 440. For each virtual subject 460, the UI display 440 may include the global ID 464 assigned to the anchor for the corresponding tracked subject. The global ID 464 may be an anonymized identifier, and/or may correlate to a more personal identifier such as a subject's name, employee number, customer number, account number, student number, and/or other identifier associated with a tracked subject. In some embodiments, for one or more of the virtual subjects 460, the RTLS 100 may update a path indicator 462 that illustrates a tracked subject's past positions and/or movements over a selectable duration of time.

As discussed herein, the subject evaluation functions 162 may control one or more operations of an AMR and/or an ego-machine, based on the location of the one or more of the tracked subjects as represented by the subject tracking data 160. In some embodiments, the UI display 440 may display the positions and/or movements of virtual subjects 460 representing tracked subjects in the monitored area 405 in relation to the positions and/or movements of one or more AMR 470. In some embodiments, the UI display 440 may display alternate routes 471 and 472 for navigating the AMR 470 through the monitored area that avoid congestion and/or avoid interactions with tracked subjects, and/or display route-changing events due to blockages.

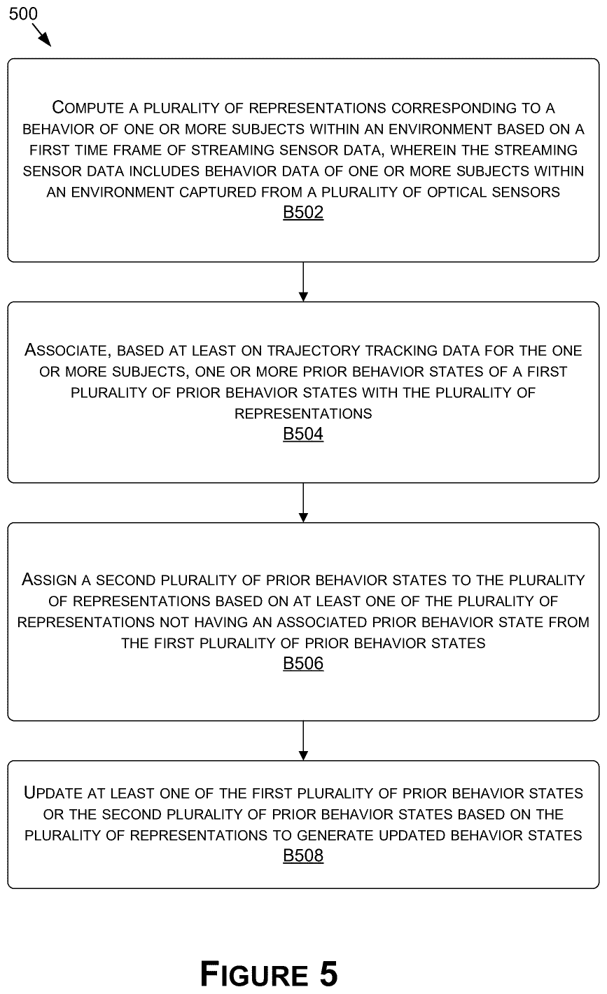

FIG. 5 is a flow diagram showing a method 500 for multi-sensor real-time subject tracking for monitored environments, in accordance with some embodiments of the present disclosure. It should be understood that the features and elements described herein with respect to the method 500 of FIG. 5 may be used in conjunction with, in combination with, or substituted for elements of any of the other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa. Each block of method 500, described herein, comprises a computing process that may be performed using any combination of hardware, firmware, and/or software. For instance, various functions may be carried out by one or more processors comprising processing circuitry to execute instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 500 is described, by way of example, with respect to the RTLS 100 of FIG. 1. However, the method may additionally or alternatively be executed by any one system, or any combination of systems, including, but not limited to, those described herein.

As discussed herein in greater detail, in some embodiments the method may include generating behavior states representing behavior data for one or more tracked subjects within a monitored area, based on a plurality of behavior embeddings computed from synchronized optical image streaming data representing the monitored area. The behavior states are updated based using the plurality of behavior embeddings based at least on one or both of: associating, based at least on trajectory tracking data, a first set of individual behavior embeddings of the plurality of behavior embeddings with one or more prior behavior states of a first plurality of prior behavior states computed from the synchronized optical image streaming data; and selectively applying an assignment process to assign a second plurality of prior behavior states to a second set of individual behavior embeddings of the plurality of behavior embeddings, based on at least one of the plurality of behavior embeddings not having an associated prior behavior state from the first plurality of prior behavior states.

The method 500, at block B502, includes a plurality of representations corresponding to a behavior of one or more subjects within an environment based on a first time frame of streaming sensor data, wherein the streaming sensor data includes behavior data of one or more subjects within an environment captured from a plurality of optical sensors. The streaming sensor data may include behavior data captured from a plurality of optical sensors and may represent one or more tracked subjects within a monitored area. The plurality of representations (e.g., behavior embeddings) individually may represent the behavior data for an individual tracked subject of the one or more tracked subjects. As discussed above, the RTLS 100 may include behavior extraction 110 that operates to produce behavior embeddings 120 based on image data 104, where the image data 104 represents a monitored area as captured by a plurality of optical image sensors 102. The image data may include synchronized optical image streaming data based on live-streaming feeds from the plurality of optical image sensors. The streaming sensor data may comprise synchronized optical image streaming data that includes individual image feeds from the plurality of optical sensors, wherein the plurality of optical sensors are synchronized to capture the individual image feeds at the same time. In some embodiments, the image data includes synchronized optical image streaming data based on batches of previously recorded live-streaming feeds from the plurality of optical image sensors. The RTLS may process the image data as sequential micro-batches, for example where each micro-batch defines a distinct sub-second time frame of the image data. The image data may be processed using behavior extraction to extract behavior embeddings that represent individual behaviors of tracked subjects represented in the image data.

Each behavior embedding may comprise a representation of a tracked subject as appearing in an individual feed of image data associated with a distinct one of the optical image sensors. The representation provided by a behavior embedding may comprise behavior data that includes appearance data (e.g., characterizing the appearance of the tracked subject) and/or spatiotemporal data (e.g., characterizing the location and/or trajectory of the tracked subject with respect to the monitored area). The plurality of behavior embeddings may be mapped to a global image coordinate system based on camera calibration parameters associated with the plurality of optical sensors. In some embodiments, the method may include generating the plurality of behavior embeddings using a machine learning model trained to detect characteristics representing the one or more tracked subjects based on the streaming sensor data. For example, behavior embeddings may be computed using a behavior encoding model (e.g., a machine learning model). The behavior encoding model may comprise, for example, a re-identification (Re-ID) embedding model that encodes the appearance of each tracked subject appearing in the image data.

In some embodiments, the method may define one or more anchors to associate individual prior behavior states from at least one of the first plurality of prior behavior states and the second plurality of prior behavior states with a global identifier (ID). For example, an RTLS may comprise an RTLS state management function that produces and maintains anchors (and their corresponding behavior states) for tracking subjects that are observable within the monitored area, based on behavior embeddings produced from sequences of image data over a series of time frames. The RTLS state management function may assign clusters of behavior embeddings to anchors, where each anchor represents a distinct tracked subject within the monitored area. Each anchor has a corresponding behavior state wherein behavior data for the distinct tracked subject may be maintained, associated with a global ID, and tracked over time.

The method 500, at block B504, includes associating, based at least on trajectory tracking data for the one or more subjects, one or more prior behavior states of a first plurality of prior behavior states with the plurality of representations. The first plurality of prior behavior states may be derived using a second time frame of the streaming sensor data occurring prior to the first time frame. For example, as discussed herein with respect to FIGS. 1 and 3, the behavior embeddings may be received by an RTLS state management that includes a trajectory tracking function. In some embodiments, the trajectory tracking may use a continuity of trajectory analysis to associate prior behavior states and live anchors from previous time frames with the behavior embeddings derived from the current micro-batch of live streaming data, to identify tracked live anchors that may be propagated forward as live anchors and updated.

The trajectory tracking may comprise a subject tracking continuity analysis, based on the behavior data included in behavior embeddings. For each prior behavior state associated with a live anchor, the trajectory tracking may use prior location and trajectory data to compute an expected current location and trajectory given the elapsed time between iterations. Behavior embeddings that include location and trajectory data within a threshold distance of an expected current location and trajectory computed from a prior behavior state for a live anchor from the preceding time frame (e.g. the immediate prior micro-batch of image data) may be assigned to the anchor for that prior behavior state and used to define a set of tracked live anchor(s). The tracked live anchor(s) may then be processed using behavior state propagation to update the prior behavior state(s).

The method 500, at block B506, includes assigning a second plurality of prior behavior states to the plurality of representations based on at least one of the plurality of representations not having an associated prior behavior state from the first plurality of prior behavior states. The second plurality of prior behavior states may be derived using one or more time frames of the streaming sensor data occurring prior to the first time frame. For example, in order to identify when the remaining behavior embeddings are associated with a dormant anchor, the RTLS may perform an assignment process that comprises a hierarchical clustering process followed by a matching algorithm. As discussed above, the method may selectively apply the assignment process to determine when one or more of the un-associated embeddings 146 can be associated with a dormant anchor 138. The RTLS state management 130 may apply an assignment process that comprises behavior embedding clustering 148 followed by one or more matching algorithms 150. The RTLS state management may selectively execute the complex clustering and/or matching algorithms of the assignment process for those instances where behavior embeddings remain that cannot be associated with live anchors, and apply the assignment process to those remaining behavior embeddings. Processing resources of the RTLS system are therefore more efficiently utilized by using the less computationally intensive trajectory tracking first to match current behavior embeddings to existing live anchors, and then selectively applying the assignment process to those behavior embeddings that cannot be matched using trajectory tracking. As such, the RTLS may process each micro-batch of live streaming data quickly enough to support real-time multi-camera multi-subject tracking applications in high-density environments, for example where the location and trajectory tracking data for multiple subjects may be simultaneously computed and/or displayed within a short period (e.g., within one second or less) of the micro-batch of live streaming data being captured.

Accordingly, in some embodiments, the assignment process may cluster the at least one of plurality of behavior embeddings not having the associated prior behavior state from the first plurality of prior behavior states to generate one or more clusters based at least on similarity; and selectively apply a matching algorithm to assign the second plurality of prior behavior states to the one or more clusters. A new anchor and corresponding behavior state may be initialized for at least one cluster of the one or more clusters based on the at least one cluster not being assigned at least one of the second plurality of prior behavior states by the matching algorithm.

In some embodiments, clustering of behavior embeddings not having an associated prior behavior state may include a hierarchical clustering process that performs operations to: determine a subject prediction number based on a first clustering process that clusters at least one of the plurality of behavior embeddings, not having the associated prior behavior state, based at least on a similarity of behavior embeddings; and apply to the at least one of the plurality of behavior embeddings, not having the associated prior behavior state, a second clustering process that is constrained to cluster the at least one of the plurality of behavior embeddings, not having the associated prior behavior state, based at least on the subject prediction number. Moreover, the matching algorithm may comprise at least one of: an iterative matching combinatorial optimization algorithm; an algorithm that solves an assignment problem by matching agents to tasks; a Hungarian matching algorithm; a Kuhn-Munkres algorithm; or a Munkres assignment algorithm.

The method 500, at block B508, includes updating at least one of the first plurality of prior behavior states or the second plurality of prior behavior states based on the plurality of representations to generate updated behavior states. For example, behavior state propagation may generate updated behavior states associated with the tracked live anchor(s) that include the corresponding current behavior data from the behavior embeddings. The behavior state propagation 156 may also, or instead, generate one or more updated behavior states associated with the matched dormant anchors. Based on the updated behavior states, RTLS states may be updated to include the corresponding current behavior data based on current behavior embeddings.

Subject tracking data derived from the RTLS states and/or behavior states of live anchors may be used as input, for example, by one or more subject evaluation functions (e.g., analytics, query, and/or rendering systems). As discussed herein, the subject evaluation function(s) may comprise a query by example (QBE) functionality, utilizing global IDs and behavior embeddings produced by the RTLS. Behavior embeddings and/or other behavior data associated with one or more tracked subjects may be stored in a database (e.g., a Milvus database, vector database, and/or other vector database management system (VDBMS)) to support long-term QBE queries spanning over selected time periods. The subject tracking data may be generated based on queries performed using the QBE functionality. In some embodiments, the one or more subject evaluation functions may use subject tracking data (and/or other data from the RTLS representing behavior data) to control the operation of one or more machines and/or systems. For example, the subject evaluation functions may control one or more operations of an AMR and/or an ego-machine, based on the location of the one or more of the tracked subjects as represented by the subject tracking data. In some embodiments, the one or more subject evaluation functions 162 may include a rendering system to display via a UI a comprehensive view of the monitored area and visually render location and trajectory tracking data for each subject in the area as indicted by the subject tracking data, such as discussed with respect to FIGS. 4A and 4B. The UI may comprise a computer vision-based view of the one or more tracked subjects for at least a portion of the monitored area based at least on the updated behavior states.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), systems for performing light transport simulation, systems for performing collaborative content creation for 3D assets, systems implemented at least partially using cloud computing resources, and/or other types of systems.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof. In some embodiments, on or more functions of the RTLS 100 disclosed herein may be implemented as code executed by computing device(s) 600, for example using CPUs 606 and/or GPUs 608,

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se. In some embodiments, database 164 may be implemented at least in part using memory 604.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608. In some embodiments, a behavior encoding model 220 may be implemented at least in part using one or more of the GPU(s) 608.

Examples of the logic unit(s) 620 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.). In some embodiments, one or more UI used in conjunction with the RTLS 100 may be displayed using one or more of the presentation component(s) 618.

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM). In some embodiments, on or more functions of the RTLS 100 disclosed herein may be implemented as code executed by computing device(s) 600, for example using one or more of the node C.R.s 716(1)-716(N).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources. In some embodiments, on or more functions of the RTLS 100 disclosed herein may be implemented using one or more application(s) 742 and/or software 732.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein. For example, in some embodiments, may be at least in part trained and/or implemented using the data center 700.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
compute a plurality of representations corresponding to a behavior of one or more subjects within an environment based on a first time frame of streaming sensor data, wherein the streaming sensor data includes behavior data of one or more subjects within an environment captured from a plurality of optical sensors;
associate, based at least on trajectory tracking data for the one or more subjects, one or more prior behavior states of a first plurality of prior behavior states with the plurality of representations;
assign a second plurality of prior behavior states to the plurality of representations based on at least one of the plurality of representations not having an associated prior behavior state from the first plurality of prior behavior states; and
update at least one of the first plurality of prior behavior states or the second plurality of prior behavior states based on the plurality of representations to generate updated behavior states.

2. The one or more processors of claim 1, wherein the processing circuitry is further to:
define one or more anchors to associate individual prior behavior states from at least one of the first plurality of prior behavior states and the second plurality of prior behavior states with a global identifier (ID).

3. The one or more processors of claim 1, wherein the processing circuitry is further to execute the assignment process to:
cluster the at least one of the plurality of representations not having the associated prior behavior state from the first plurality of prior behavior states to generate one or more clusters based at least on similarity; and
assign, using a matching algorithm, the second plurality of prior behavior states to the one or more clusters.

4. The one or more processors of claim 3, wherein the processing circuitry is further to:
initialize a new anchor and corresponding behavior state for at least one cluster of the one or more clusters based on the at least one cluster not being assigned at least one of the second plurality of prior behavior states by the matching algorithm.

5. The one or more processors of claim 3, wherein the processing circuitry is further to cluster the at least one of the plurality of representations not having the associated prior behavior state, based on a hierarchical clustering process that performs operations to:
based at least on a similarity of representations in the plurality of representations, determine a subject prediction number based on a first clustering process that clusters at least one of the plurality of representations not having the associated prior behavior state; and
based at least on the prediction number, apply to the at least one of the plurality of representations not having the associated prior behavior state, a second clustering process to cluster the at least one of the plurality of representations not having the associated prior behavior state.

6. The one or more processors of claim 3, wherein the matching algorithm comprises at least one of:
an iterative matching combinatorial optimization algorithm;
an algorithm that solves an assignment problem by matching agents to tasks;
a Hungarian matching algorithm;
a Kuhn-Munkres algorithm; or
a Munkres assignment algorithm.

7. The one or more processors of claim 1, wherein the behavior data comprises at least one of appearance data or spatiotemporal data represented by the plurality of behavior embeddings.

8. The one or more processors of claim 1, wherein the processing circuitry is further to:
generate the plurality of representations using a machine learning model trained to detect characteristics representing the one or more subjects based at least on the streaming sensor data.

9. The one or more processors of claim 1, wherein the streaming sensor data comprises synchronized optical image streaming data that includes individual image feeds from the plurality of optical sensors, wherein the plurality of optical sensors are synchronized to capture the individual image feeds at the same time.

10. The one or more processors of claim 1, wherein the processing circuitry is further to:
map the plurality of representations to a global image coordinate system based at least on camera calibration parameters associated with the plurality of optical sensors.

11. The one or more processors of claim 1, wherein the processing circuitry is further to cause a display of a computer vision-based view of the one or more subjects for at least part of the environment based at least on the updated behavior states.

12. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

13. A system comprising one or more processors to:
generate a plurality of representations computed based on optical image streaming data representing one or more tracked subjects within a monitored area;
associate, based at least on trajectory tracking data, a first set of individual representations of the plurality of representations with one or more prior behavior states of a first plurality of prior behavior states computed from the optical image streaming data;
assign, using an assignment process, a second plurality of prior behavior states to a second set of individual representations of the plurality of representations, based on at least one of the plurality of representations not having an associated prior behavior state from the first plurality of prior behavior states; and
update at least one of the first plurality of prior behavior states and the second plurality of prior behavior states based on the plurality of representations to generate updated behavior states.

14. The system of claim 13, wherein the one or more processors are further to execute the assignment process to:
cluster the at least one of the plurality of representations, not having the associated prior behavior state from the first plurality of prior behavior states, to generate one or more clusters based at least on similarity; and
selectively apply a matching algorithm to assign the second plurality of prior behavior states to the one or more clusters.

15. The system of claim 14, wherein the one or more processors are further to:
initialize a new anchor and corresponding behavior state for at least one cluster of the one or more clusters based on the at least one cluster not being assigned at least one of the second plurality of prior behavior states by the matching algorithm.

16. The system of claim 14, wherein the one or more processors are further to cluster the at least one of the plurality of representations, not having the associated prior behavior state, based on a hierarchical clustering process that performs operations to:
determine a subject prediction number based on a first clustering process that clusters the at least one of the plurality of representations, not having the associated prior behavior state, based at least on a similarity of representations; and
apply to the at least one of the plurality of representations, not having the associated prior behavior state, a second clustering process that is constrained to cluster the at least one of the plurality of representations, not having the associated prior behavior state, based at least on the subject prediction number.

17. The system of claim 14, wherein the matching algorithm comprises at least one of:
an iterative matching combinatorial optimization algorithm;
an algorithm that solves an assignment problem by matching agents to tasks;
a Hungarian matching algorithm;
a Kuhn-Munkres algorithm; or
a Munkres assignment algorithm.

18. The system of claim 13, wherein the one or more processors are further to:
generate the plurality of representations using a machine learning model trained to detect characteristics representing the one or more tracked subjects based on the optical image streaming data.

19. The system of claim 13, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

20. A method comprising:
generating behavior states representing behavior data for one or more subjects within an environment, based on a plurality of representations computed from optical image streaming data representing the environment, wherein the behavior states are updated based using the plurality of representations based at least on one of:
associating, based at least on trajectory tracking data, a first set of individual representations of the plurality of representations with one or more prior behavior states of a first plurality of prior behavior states computed from the optical image streaming data; and
applying an assignment process to assign a second plurality of prior behavior states to a second set of individual representations of the plurality of representations, based on at least one of the plurality of representations not having an associated prior behavior state from the first plurality of prior behavior states.
